(19) United States
(12) Patent Application Publication
(10) Pub. No.: US 2011/0289121 A1
(43) Pub. Date: Nov. 24, 2011

(54) METADATA MODIFIER AND MANAGER

(75) Inventor: Christian Pirkner, Lachen (CH)

(73) Assignee: ROVI TECHNOLOGIES CORPORATION, Santa Clara, CA (US)

(21) Appl. No.: 12/851,281

(22) Filed: Aug. 5, 2010

Related U.S. Application Data
(60) Provisional application No. 61/345,813, filed on May 18, 2010.

(51) Int. Cl. G06F 17/30

(52) U.S. Cl. 707/805; 707/E17.005

(57) ABSTRACT

A system for modifying media content metadata includes a processor that receives, via a graphical user interface, a signal indicating selection of a media item. The processor also receives, via the graphical user interface, a signal indicating selection of a mode from a group of modes including a single-media-item mode, a multiple-media-item mode, and an automatic mode. A fingerprint of the media item is generated. A request for metadata of the media item is transmitted to a recognition server over the communication network, the request including the fingerprint. The metadata of the media item is received over the communication network. At least a portion of the received metadata is stored according to the selected mode.

### CROSS REFERENCE TO RELATED APPLICATION

This application claims the benefit of U.S. Provisional Patent Application No. 61/345,813, filed on May 18, 2010, the disclosure of which is incorporated by reference herein in its entirety.

### BACKGROUND

1. Field

Example aspects of the present invention generally relate to media content metadata, and more particularly to systems, methods, and computer program products for modifying and managing media content metadata.

2. Related Art

The digitization of media content, such as music or movies, as well as the improvement in digital data delivery techniques, have changed the way consumers experience media content. Consumers can download digital music, movies, games, or other content via the Internet with the click of a mouse or from other content sources, such as cable or television broadcasters, and can enjoy their downloads at their convenience. In addition, the variety of media content available to consumers today is wider than ever. Consumers can browse vast collections of content from different sources via Internet or television browsers to identify a song or a movie to download. Maintaining consistent and accurate metadata for these collections, however, can be difficult given their enormity and their widely varying sources.

### BRIEF DESCRIPTION

Given the foregoing, it would be useful to have an efficient system for modifying media content metadata.

The example embodiments described herein meet the above-identified needs by providing systems, methods, and computer program products for modifying media content metadata. The system includes a processor that receives, via a graphical user interface, a signal indicating selection of a media item. The processor also receives, via the graphical user interface, a signal indicating selection of a mode from a group of modes including a single-media-item mode, a multiple-media-item mode, and an automatic mode. A fingerprint of the media item is generated. A request for metadata of the media item is transmitted to a recognition server over the communication network, the request including the fingerprint. The metadata of the media item is received over the communication network. At least a portion of the received metadata is stored according to the selected mode.

Further features and advantages, as well as the structure and operation, of various example embodiments of the present invention are described in detail below with reference to the accompanying drawings.

### BRIEF DESCRIPTION OF THE DRAWINGS

The features and advantages of the example embodiments presented herein will become more apparent from the detailed description set forth below when taken in conjunction with the drawings.

FIG. 1 is a diagram illustrating an exemplary system for modifying metadata.

FIG. 2 is a diagram illustrating an exemplary recognition server and user device for modifying media content metadata.

FIG. 3 is a flowchart diagram illustrating an exemplary procedure for modifying metadata associated with a media item.

FIG. 4 is a flowchart diagram illustrating an exemplary procedure for modifying metadata of a single media item.

FIG. 5 is a sample graphical user interface for modifying metadata of a single media item, particularly a song.

FIG. 6 is a sample graphical user interface for modifying metadata of a single video media item.

FIG. 7 is a flowchart diagram illustrating an exemplary procedure for modifying metadata of multiple media items.

FIG. 8 is a sample graphical user interface for modifying metadata of multiple media items, particularly songs.

FIG. 9 is a flowchart diagram illustrating an exemplary procedure for automatically modifying metadata of multiple media items.

FIG. 10 is a flowchart diagram illustrating an exemplary procedure for remotely modifying metadata of media items.

FIG. 11 is a flowchart diagram illustrating an exemplary procedure for remotely modifying metadata of media items from a Web site.

FIG. 12 is a block diagram of a general and/or special purpose computer system, in accordance with some embodiments.

### DETAILED DESCRIPTION

### I. Definitions

Some terms are defined below in alphabetical order for easy reference. These terms are not rigidly restricted to these definitions. A term may be further defined by its use in other sections of this description.

“Audio Fingerprint” and “acoustic fingerprint” mean a digital measure of certain acoustic properties that is deterministically generated from an audio signal that can be used to identify an audio sample and/or quickly locate similar items in an audio database. An audio fingerprint typically operates as a unique identifier for a particular item, such as, for example, a CD, a DVD and/or a Blu-ray Disc. An audio fingerprint is an independent piece of data that is not affected by metadata. Rovi™ Corporation has databases that store over 25 million unique fingerprints for various audio samples. Practical uses of audio fingerprints include without limitation identifying songs, identifying records, identifying melodies, identifying tunes, identifying advertisements, monitoring radio broadcasts, monitoring multipoint and/or peer-to-peer networks, managing sound effects libraries and identifying video files.

“Audio Fingerprinting” is the process of generating an audio fingerprint. U.S. Pat. No. 7,277,766, entitled “Method and System for Analyzing Digital Audio Files”, which is herein incorporated by reference, provides an example of an apparatus for audio fingerprinting an audio waveform. U.S. Pat. No. 7,451,078, entitled “Methods and Apparatus for Identifying Media Objects”, which is herein incorporated by reference, provides an example of an apparatus for generating an audio fingerprint of an audio recording.

“Content,” “media content” and “multimedia content,” generally mean information that is delivered via a medium for a user to experience visually and/or aurally. Examples of content include audio content, image content such as photographs, video content, digital recordings, television programming, movies, music, spoken audio, games, special features, scheduled media, on-demand and/or pay-per-view content, broadcast content, multicast content, downloaded content, streamed content, and/or content delivered by another means.

“Content source” means an originator, provider, publisher, and/or broadcaster of content. Example content sources include television broadcasters, radio broadcasters, Web sites, printed media publishers, magnetic or optical media publishers, and the like.

“Database” means a collection of data organized in such a way that a computer program may quickly select desired pieces of the data. A database is an electronic filing system. In some implementations, the term “database” may be used as shorthand for “database management system”.

“Device” means software, hardware, or a combination thereof. A device may sometimes be referred to as an apparatus. Examples of a device include without limitation a software application such as Microsoft Word™, a laptop computer, a database, a server, a display, a computer mouse, and a hard disk.

“DLNA” (Digital Living Network Alliance) is a standard used by manufacturers of consumer electronics to allow entertainment devices within the home to share their content with each other across a home network. A network may be a DLNA-compliant network.

“Link” means an association with an object or an element in memory. A link is typically a pointer. A pointer is a variable that contains the address of a location in memory. The location is the starting point of an allocated object, such as an object or value type, or the element of an array. The memory may be located on a database or a database system. “Linking” means associating with (e.g., pointing to) an object in memory.

“Media item” means a item of media content.

“Media item attribute” means a metadata item corresponding to particular characteristics of a media item. Each media item attribute falls under a particular media item attribute category. Examples of media item attribute categories and associated media item attributes for music include cognitive attributes (e.g., simplicity, storytelling quality, melodic emphasis, vocal emphasis, speech like quality, strong beat, good groove, fast pace), emotional attributes (e.g., intensity, upbeatness, aggressiveness, relaxing, mellowness, sadness, romance, broken heart), esthetic attributes (e.g., smooth vocals, soulful vocals, high vocals, sexy vocals, powerful vocals, great vocals), social behavioral attributes (e.g., easy listening, wild dance party, slow dancing, workout, shopping mall), genre attributes (e.g., alternative, blues, country, electronic/dance, folk, gospel, jazz, Latin, new age, R&B/soul, rap/hip hop, reggae, rock), sub-genre attributes (e.g., blues, gospel, motown, stax/memphis, philly, doo-wop, funk, disco, old school, blue-eyed soul, adult contemporary, quiet storm, crossover, dance/techno, electro/synth, new jack swing, retro/alternative, hip hop, rap), instrumental/vocal attributes (e.g., instrumental, vocal, female vocalist, male vocalist), backup vocal attributes (e.g., female vocalist, male vocalist), instrument attributes (e.g., most important instrument, second most important instrument), etc.

Examples of media item attribute categories and associated attributes for movies include genre (e.g., action, animation, children and family, classics, comedy, documentary, drama, faith and spirituality, foreign, high definition, horror, independent, musicals, romance, science fiction, television, thrillers), release date (e.g., within past six months, within past year, 1980s), etc.

Other media item attribute categories and media item attributes are contemplated and are within the scope of the embodiments described herein.

“Media item fingerprint”, “fingerprint”, “digital fingerprint”, and “signature” mean a digital measure of certain physical properties that is deterministically generated from a digital signal that can be used to identify a sample of a media item, and/or quickly locate similar media items in a database. Example media item fingerprints include an audio fingerprint, a video fingerprint, and/or a digital signature of any other digital media object. A fingerprint may also be a watermark or other identifier, such as text from the media item or associated file or record that can be used to identify the media item.

“Metadata,” which may also be referred to herein as media content metadata and/or as “content information,” generally means data that describes data. More particularly, metadata refers to information associated with or related to one or more items of media content and may include information used to access the media content. The metadata provided and/or delivered by various embodiments is designed to meet the needs of the user in providing a rich media metadata browsing experience. Such metadata may include, for example, a track name, a song name, artist information (e.g., name, birth date, discography), album information (e.g., album title, review, track listing, sound samples), relational information (e.g., similar artists and albums, genre), and/or other types of supplemental information such as advertisements, links or programs (e.g., software applications), and related images. Metadata may also include a program guide listing of the songs or other audio content associated with multimedia content. Conventional optical discs (e.g., CDs, DVDs, Blu-ray Discs) do not typically contain metadata. Metadata may be associated with content (e.g., a song, an album, a movie or a video) after the content has been ripped from an optical disc, converted to another digital audio format, and stored on a hard drive. Content information and/or metadata may be stored together with, or separately from, the underlying content that is described by the content information and/or metadata.

“Network” means a connection between any two or more computers, which permits the transmission of data. A network may be any combination of networks, including without limitation the Internet, a local area network (e.g., home network, intranet), a wide area network, a wireless network, and a cellular network.

“Server” means a software application that provides services to other computer programs (and their users), in the same or another computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Software” and “application” mean a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++, and Java. Further, the functions of some embodiments, when described as a series of steps for a method, could be implemented as a series of software instructions for being operated by a processor, such that the embodiments could be implemented as software, hardware, or a combination thereof. Computer-readable media are discussed in more detail in a separate section below.

“System” means a device or multiple coupled devices. A device is defined above.

“User” means a consumer, client, and/or client device in a marketplace of products and/or services.

“User device” (e.g., “client”, “client device”, “user computer”) is a hardware system, a software operating system, and/or one or more software application programs. A user device may refer to a single computer or to a network of interacting computers. A user device may be the client part of a client-server architecture. A user device typically relies on a server to perform some operations. Examples of a user device include without limitation a television (TV), a CD player, a DVD player, a Blu-ray Disc player, a personal media device, a portable media player, an iPod™, a Zoom Player, a laptop computer, a palmtop computer, a smart phone, a cell phone, a mobile phone, an MP3 player, a digital audio recorder, a digital video recorder (DVR), a set-top-box (STB), a network-attached storage (NAS) device, a gaming device, an IBM-type personal computer (PC) having an operating system such as Microsoft Windows™, an Apple™ computer having an operating system such as MAC-OS, hardware having a JAVA-OS operating system, and a Sun Microsystems Workstation having a UNIX operating system.

“Web browser” means any software program which can display text, graphics, or both, from Web pages on Web sites. Examples of a Web browser include without limitation Mozilla Firefox™ and Microsoft Internet Explorer™.

“Web page” means any documents written in a mark-up language including without limitation HTML (hypertext mark-up language) or VRML (virtual reality modeling language), dynamic HTML, XML (extensible mark-up language) or related computer languages thereof, any collection of such documents reachable through one specific Internet address or at one specific Web site, or any document obtainable through a particular URL (Uniform Resource Locator).

“Web server” refers to a computer or other electronic device which is capable of serving at least one Web page to a Web browser. An example of a Web server is a Yahoo™ Web server.

“Web site” means at least one Web page, and more commonly a plurality of Web pages, virtually coupled to form a coherent group.

### II. Overview

Systems, methods, apparatus and computer-readable media are provided for modifying and managing media content metadata. In one aspect, a user device receives, via a graphical user interface (GUI), a signal indicating selection of a single-media-item mode, a multiple-media-item mode, or an automatic mode. Depending on the selected mode, the user device further receives, via the GUI, a signal indicating a selection of a media item or group of media items.

A fingerprint for each selected media item is generated and used to generate one or more request packets, which are, in turn, transmitted over a communication network to a recognition server. Each request packet causes the recognition server to communicate metadata for each media item back over the communication network.

The metadata from the recognition server is received by the user device and stored in a digital file of the media item, a database, or a combination of both, according to the selected mode, type of media item, and commands received via the GUI.

For simplicity the embodiments presented herein are described as operating with respect to one media item. Modification of metadata associated with a group of media items is also contemplated and within the scope of the embodiments described herein.

### III. System Architecture

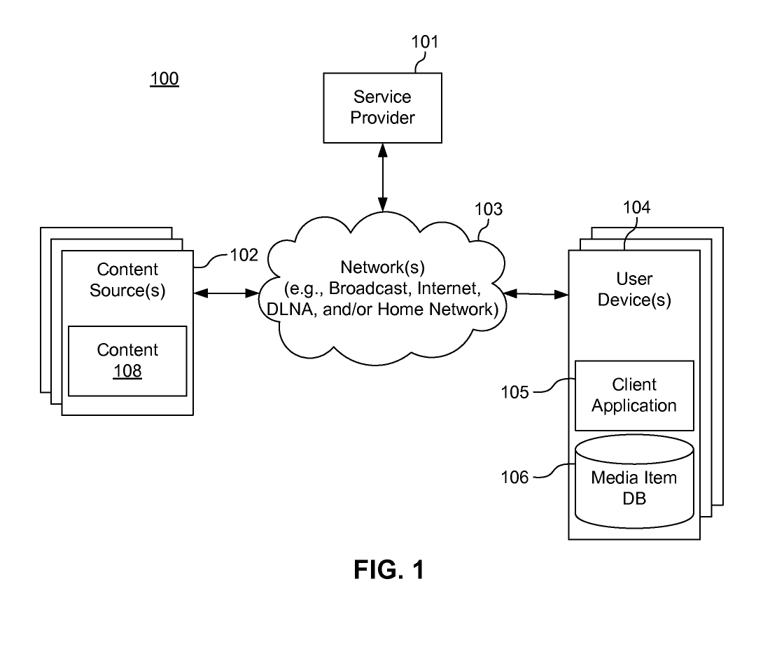

FIG. 1 is a diagram illustrating an exemplary system 100 for modifying metadata. The system 100 includes a recognition server 101, content source(s) 102, and user device(s) 104, which are communicatively coupled to each other via network(s) 103. Generally, a user device 104 generates a request for metadata and communicates the requests to the recognition server 101 over the network 103 based on input received from a user. The user device 104 also manages the metadata of all the media items its stores. Stored in the memory of the user device 104 is a client application 105, which when executed by a processor, provides a graphical user interface (GUI) that accepts input from the user. The user makes a selection, via the GUI, to cause a modification of the metadata associated with a media item that has been prestored on the user device 104. If no metadata is associated with a media item, then commands to add metadata can be received by the user device 104. Metadata that has been prestored within a media item or in the user device 104 is referred herein as “prestored metadata.”

Recognition server 101 receives the packet containing the request(s) and compares the fingerprint(s) within each request to a database of known fingerprints it stores to identify the media content. If a match is found, the recognition server 101 returns metadata associated with the identified media item to the user device 104 from its recognition server database 212.

In another embodiment, the request generated by user device 104 extracts information from a media item and uses that information, or a derivative of that information, as the fingerprint. As described above, a fingerprint need not be generated from the content or physical properties of the media item itself. Instead, the media item may contain information in the form of text or a watermark that can be used to identify it. Accordingly, instead of generating a fingerprint from the content or physical properties of the media item, the application 105 can cause the processor to extract identification information from the media item itself (or an associated file) and use it as a fingerprint.

Metadata may have been obtained from expert media content reviewers, average media content reviewers, and/or public sources of media content metadata. An average media content reviewer is any individual other than an expert media content reviewer. An expert media content reviewer is an individual who is more knowledgeable in one or more media content fields, such as music, movies, and/or the like, than an average media content reviewer. An expert media content reviewer may have received training in one or more media content fields, such as music, movies, and/or the like.

In one embodiment, the metadata stored in recognition server 101 has been identified as having been generated by expert reviewers of media content. In another embodiment, the metadata stored in the recognition server 101 has been identified as having been generated by average media content reviewers. In yet another embodiment, the metadata stored in recognition server 101 has been identified as having been obtained from public databases. Alternatively, the metadata stored in recognition server 101 has been obtained from a combination of expert reviewers, average reviewers, and/or public sources of metadata, and pre-stored into the recognition server database 202. An identifier indicating that the metadata is based on an aggregation or combined version of the reviewed metadata and metadata obtained from a public database can also be associated with one or more media items. The identifier also can be embodied as an attribute within the metadata data structure and transmitted by the recognition server to the user device 104 and displayed to provide a user with an indication of the source of the metadata.

The user device 104 accepts commands from a user to modify each attribute of the metadata of the media content by making selections through a user interface, thereby causing one or more attributes of the metadata received from the recognition server 101 to be stored in association with the media item on the user device 104. The term “modifying” as used herein means amending, adding, deleting, transforming, and/or converting. Metadata stored on the user device 104 prior to the transmission of request(s) to obtain metadata from the recognition server 101 may include attributes that contain some or no data.

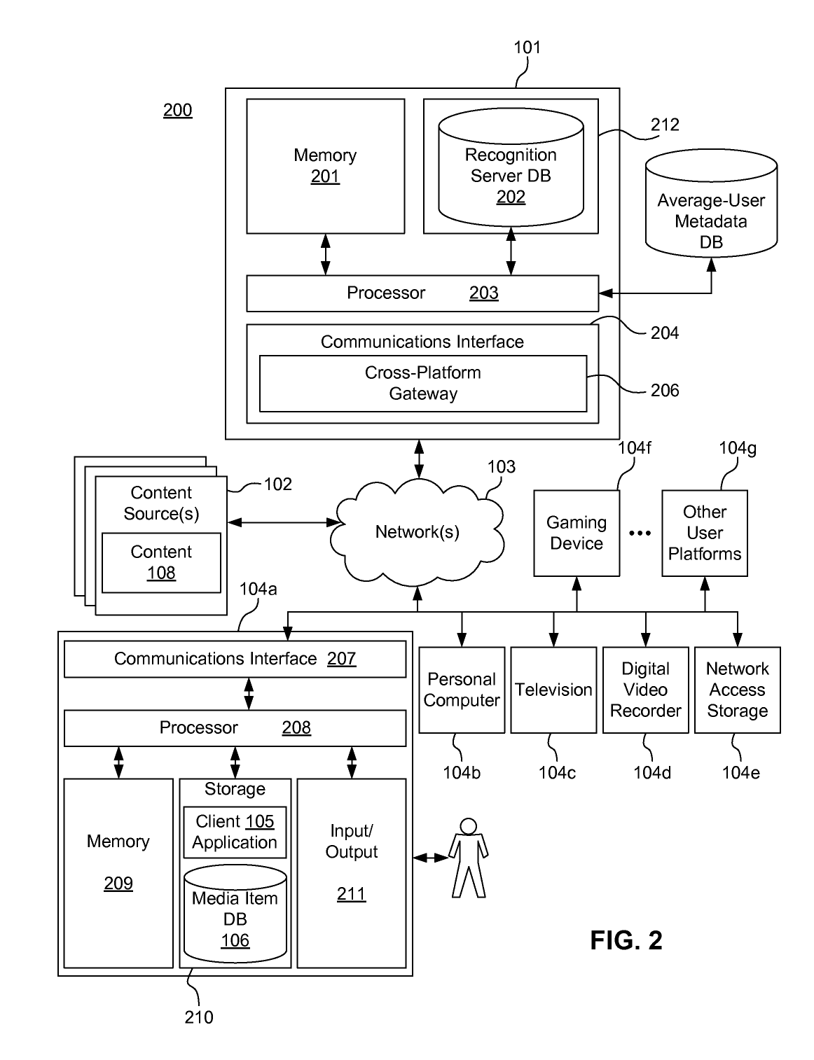

FIG. 2 is a diagram 200 illustrating an exemplary recognition server 101 and user device 104 for modifying media content metadata.

### A. Recognition Server

As shown in FIG. 2, the recognition server 101 includes a processor 203, which is coupled through a communication infrastructure (not shown) to a memory 201, a storage device 212 including a recognition server database 202, and a communications interface 204.

The recognition server database 202 includes a collection of media item fingerprints and corresponding metadata. The media item fingerprints are used by the processor 203 as bases for comparison to identify media item fingerprints received from user devices 104a, 104b, 104c, 104d, 104e, 104f and 104g (collectively 104). The metadata stored on the recognition server 101 includes tags, which are digital storage fields corresponding to particular media item attributes of particular media items.

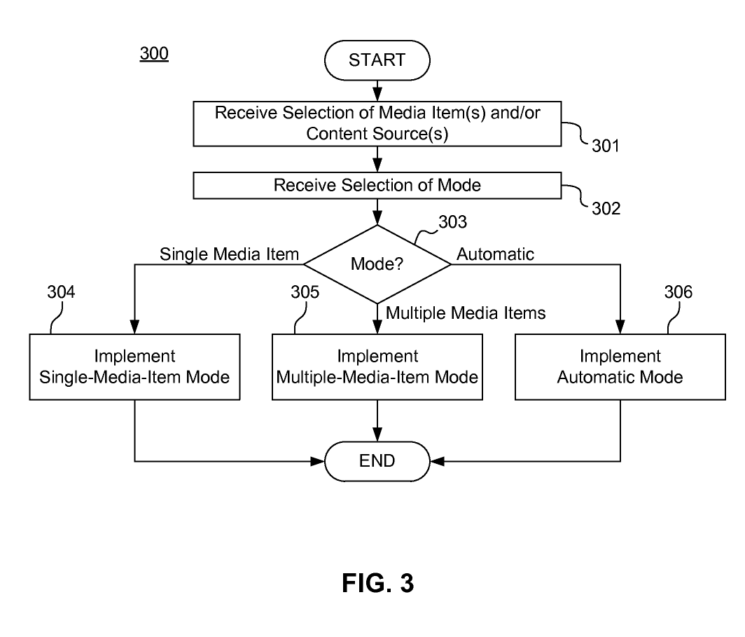

An ID3 tag, as used with an mp3 formatted file, is an example tag that allows media item attribute information to be stored within a media item file itself. As described below with respect to FIGS. 3-10, a user can update media content metadata on a tag-by-tag basis.

The recognition server 101 also includes a main memory 201 and a storage device 212. In some embodiments, the main memory 201 is random access memory (RAM). The recognition server database 202 stores metadata, and can be part of or separate from the storage device 212. The storage device 212 (also sometimes referred to as “secondary memory”) may also include, for example, a hard disk drive and/or a removable storage drive, representing a disk drive, a magnetic tape drive, an optical disk drive, etc. As will be appreciated, the storage device 212 may include a computer-readable storage medium having stored thereon software and/or data.

In alternative embodiments, the storage device 212 may include other similar devices for allowing software or other instructions to be loaded into the recognition server 101. Such devices may include, for example, a removable storage unit and an interface, a program cartridge and cartridge interface such as that found in video game devices, a removable memory chip such as an erasable programmable read only memory (EPROM), or programmable read only memory (PROM) and associated socket, and other removable storage units and interfaces, which allow software and data to be transferred from the removable storage unit to the recognition server 101.

The recognition server 101 includes the communications interface 204 to provide connectivity to the network 103. The communications interface 204 also allows software and data to be transferred between the recognition server 101 and external devices. Examples of the communications interface 204 may include a modem, a network interface such as an Ethernet card, a communications port, a Personal Computer Memory Card International Association (PCMCIA) slot and card, etc. Software and data transferred via the communications interface 204 are in the form of signals which may be electronic, electromagnetic, optical, or other signals capable of being received by the communications interface 204. These signals are provided to and/or from the communications interface 204 via a communications path, such as a channel. This channel carries signals and may be implemented by using wire, cable, fiber optics, a telephone line, a cellular link, an RF link, and/or other suitable communications channels.

The communications interface 204 also includes a cross platform gateway (CPGW) or “platform gateway” 206. The platform gateway 206 is an interface between the recognition server 101 and user devices 104 that enables the recognition server 101 to communicate with different user devices 104 despite the user devices 104 using different communication protocols.

### B. User Device

FIG. 2 also illustrates multiple user devices 104a, 104b, 104c, 104d, 104e, 104f and 104g (collectively 104) communicatively coupled to each other via a network 103. The user devices 104 include a personal computer (PC) 104b, a television (TV) 104c, a digital video recorder (DVR) 104d, a network-attached storage (NAS) 104e, a gaming device 104f, and/or other user devices 104g. A more detailed diagram of an exemplary user devices is depicted as user device 104a. As shown in FIG. 2, user device 104a includes a processor 208, which is coupled through a communication infrastructure (not shown) to a memory 209, a storage device 210 including a client application 105 and media item database 106, a communications interface 207, and an input/output interface 211. The input/output interface 211 may include a graphical user interface (GUI); input devices, such as a mouse, a keyboard, etc.; output devices, such as a monitor, and/or the like.

Generally, a user device 104 communicates to recognition server 101 requests for metadata of media content stored in its storage 210. In one embodiment, the request is initiated by a user by using a graphical user interface (GUI).

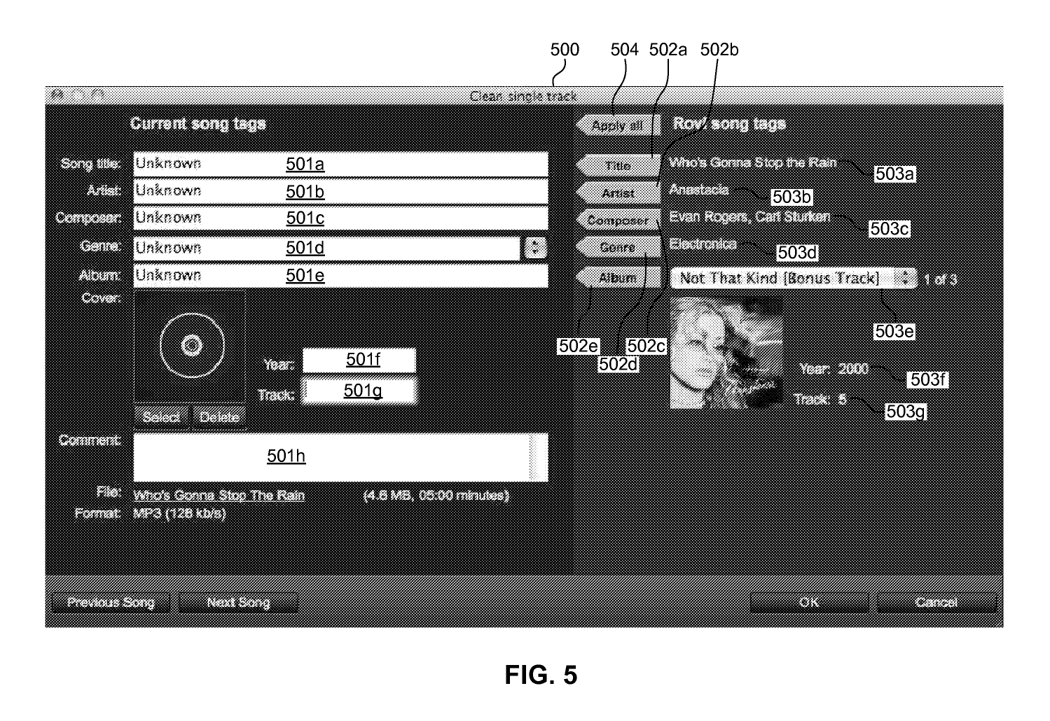

Particularly, client application 105, when executed by processor 208, causes the processor 208 to generate a GUI via the input/output interface 211. Example GUIs are described in further detail below with respect to FIGS. 5, 6, and 8. The processor 208 receives via the input/output interface 211, a request for metadata for one or more media items. In response to receiving such a request, the processor 208 retrieves a portion of a media item or other identifier from the media item (e.g., table of contents or TOC, watermark, etc.) and generates (or extracts) a media item fingerprint for the media item. In some embodiments, the metadata may contain a link to a remote source such as content source 102. Accordingly, the media item may be located either in media item database 106 within the storage 210 or in remote content source(s) 102 accessible through a network 103.

The processor 208 communicates the media item fingerprint to the recognition server 101 via the communications interface 207.

Depending on a mode selected by the user, also via the GUI, the user device 104 generates a fingerprint for each media item stored in, or having a link stored in, the media item database 106 for which metadata is requested. The client application 105 then causes the processor 208, to communicate the metadata request(s) which include one or more fingerprint via its communication interface 207 onto the network 103, addressing the request(s) to the recognition server 101.

The user device 104a can also receive from the network 103, via its communications interface 207, the metadata obtained from the recognition server 101. As described below in more detail with respect to FIGS. 3-10, the preexisting metadata of the media item stored on the user device 104, if any, can be updated by storing the metadata received from the network (e.g., originating from a recognition server 101) in corresponding records associated with the media item. Alternatively, the file itself may be modified with the updated metadata.

In some embodiments, the storage device 210 includes media items, which already contain metadata, in the media item database 106. An mp3 file, for example, may contain metadata associated with the media content within the file itself in ID3 tags. In other embodiments, the tags are stored in a database that is distinct from the media item file. In this case, each tag is stored in the database along with an identifier of the corresponding media item.

Metadata associated with a media item may also have been obtained from a recognition server and stored apart from the media item, for example, within a record stored in the storage device 210. In either case, the metadata can be modified based on instructions input by a user through the input/output interface 211.

The media items can be prestored in the media item database 106 and/or retrieved from external content source(s) 102 via the network 103. In still another aspect, one user device, such as the user device 104a, may remotely modify metadata stored on another user device, such as the digital video recorder 104d.

The storage device 210 may also include, for example, a hard disk drive and/or a removable storage drive, representing a disk drive, a magnetic tape drive, an optical disk drive, etc. As will be appreciated, the storage device 210 may include a computer-readable storage medium having stored thereon software and/or data.

In alternative embodiments, the storage device 210 may include other similar devices for allowing software or other instructions to be loaded into the user device 104a. Such devices may include, for example, a removable storage unit and an interface, a program cartridge and cartridge interface such as that found in video game devices, a removable memory chip such as an erasable programmable read only memory (EPROM), or programmable read only memory (PROM) and associated socket, and other removable storage units and interfaces, which allow software and data to be transferred from the removable storage unit to the user device 104a.

The communications interface 207 provides the user device 104a with connectivity to the network(s) 103. The communications interface 207 also allows software and data to be transferred between the user device 104a and external devices. Examples of the communications interface 207 may include a modem, a network interface such as an Ethernet card, a communications port, a Personal Computer Memory Card International Association (PCMCIA) slot and card, etc. Software and data transferred via the communications interface 207 are in the form of signals which may be electronic, electromagnetic, optical, or other signals capable of being received by the communications interface 207. These signals are provided to and/or from the communications interface 207 via a communications path, such as a channel. This channel carries signals and may be implemented by using wire, cable, fiber optics, a telephone line, a cellular link, an RF link, and/or other suitable communications channels.

### IV. Procedure

### A. Overview

FIG. 3 is a flowchart diagram illustrating an exemplary procedure 300 for modifying metadata associated with a media item.

At block 301, the processor 208 receives, via a GUI provided to the input/output interface 211 by the client application 105, a selection of media item(s) and, optionally, content source(s). In some embodiments, the GUI displays a list of the media items from the media item database 106 stored in the storage device 210. In this case, the user device 104 can be used to modify metadata of media item(s). Particularly, an icon, text, link, or other graphic symbol that denotes a command (referred to as an “input command object”) in the graphical user interface, may be selected by the user, where each input command object is associated with a media item or tag associated with the metadata of the media item. The media item need not explicitly relate to a particular content source 102.

In other embodiments, the GUI displays one or more input command objects corresponding to multiple content sources 102, which when selected by the user, causes the processor to generate and communicate access requests over the network 103 to one or more of the content sources 102. In this case, after receiving selection of a content source, the client application 105 causes the GUI to display a list of the media items corresponding to the content 108 stored on the content source 102. The device is then ready to accept user input via the input/output interface 207 to modify metadata of media item(s) by selecting the appropriate input command objects.

At block 302, the processor 208 receives, from the user via the input/output interface 211, a selection of either a single-media-item mode, a multiple-media-item mode, or an automatic mode.

A user selects a single-media-item mode by selecting an input command object corresponding to a single media item displayed via the GUI, and then selecting an input command object corresponding to an instruction to modify that selected media item.

A user selects a multiple-media-item mode by selecting input command objects of multiple media items displayed via the GUI, and then selecting an input command object corresponding to an instruction to modify those selected media items.

A user selects an automatic mode by selecting an input command object corresponding to an instruction to automatically modify all media items of the content stored within the currently selected content source 102 or storage 210, as the case may be.

At block 303, the processor 208 determines which mode to implement based on the mode selection received at block 302.

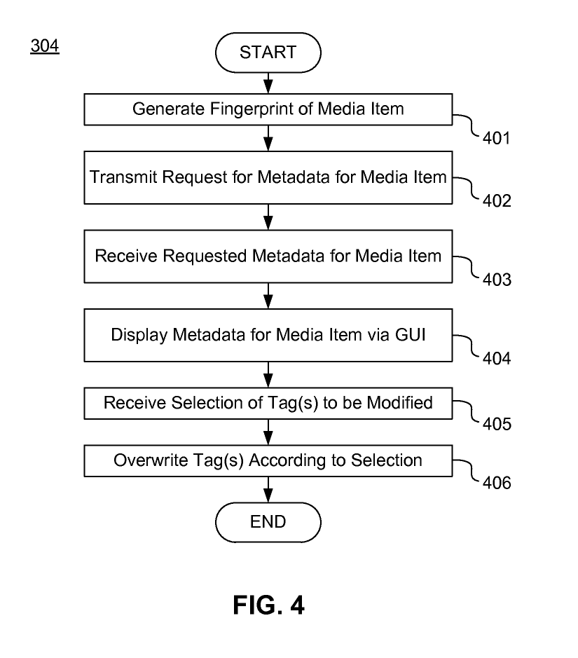

If the processor 208 determines at block 303 to implement a single-media-item mode then, at block 304, the processor 208 implements a single-media-item mode. An exemplary procedure 304 for modifying metadata of a single media item is described in further detail below with respect to FIG. 4.

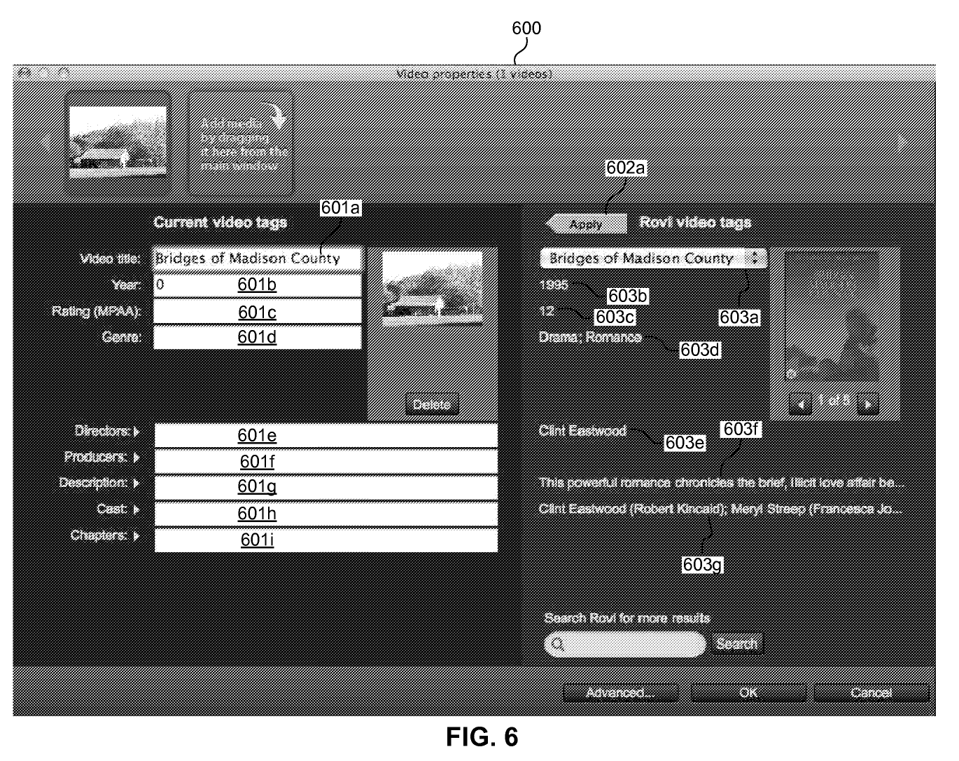

If the processor 208 determines at block 303 to implement a multiple-media-item mode then, at block 305, the processor 208 implements a multiple-media-item mode. An exemplary procedure 305 for modifying metadata of multiple media items is described in further detail below with respect to FIG. 6.

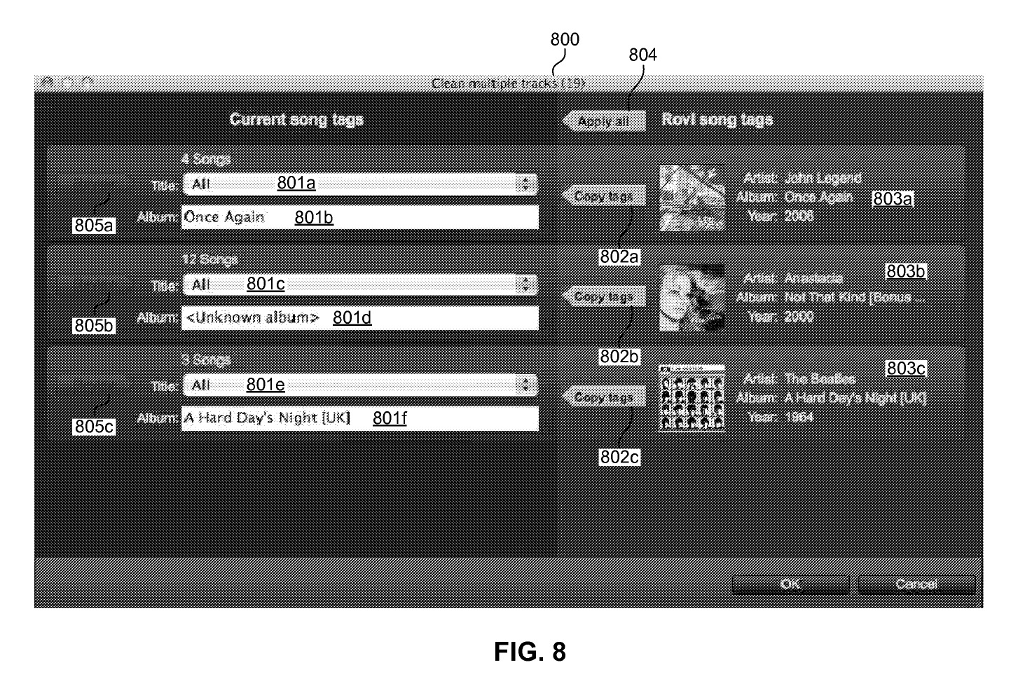

If the processor 208 determines at block 303 to implement an automatic mode then, at block 306, the processor 208 implements an automatic mode. An exemplary procedure 306 for automatically modifying metadata of media items is described in further detail below with respect to FIG. 8.

### B. Single-Media-Item Mode

FIG. 4 is a flowchart diagram illustrating an exemplary procedure 304 for modifying metadata of a single media item.

At block 401, the processor 208 generates a fingerprint of the media item that was selected at block 301 (FIG. 3).

At block 402, the processor 208 transmits to the recognition server 101 over the network 103 a request for metadata of the media item corresponding to the fingerprint. The recognition server processor 203 accesses the recognition server database 202 to identify a fingerprint stored therein that matches the fingerprint received from the user device processor 208. The recognition server processor 203 accesses the recognition server database 202 to obtain metadata corresponding to the media item associated with the matched fingerprint.

At block 403, user device 104 receives from the network 103 the metadata communicated by the recognition server 101.

The metadata is then processed by the processor 208. Particularly, at block 404, the client application 105 causes the user device processor 208 to format the metadata into a user-viewable format and display the formatted metadata via the GUI on the input/output interface 211.

FIG. 5 is a sample graphical user interface (GUI) 500 for modifying metadata of a single media item, particularly a song. With reference to FIGS. 4 and 5, in one embodiment, each tag of the metadata obtained from the recognition server, metadata 503a, 503b, 503c, 503d, 503e, 503f and 503g (collectively 503), is displayed beside the corresponding tag of the metadata previously stored on the content source 102 or storage device 210 for the media item, metadata 501a, 501b, 501c, 501d, 501e, 501f, 501g and 501h (collectively 501). Beside each tag is an input command object 502a, 502b, 502c, 502d and 502e (collectively 502) corresponding to an instruction to overwrite the original metadata tags 501 originally associated with the media item (e.g., before receiving metadata from recognition server 101) with the metadata tags 503 obtained from the recognition server 101. When selected a side-by-side comparison of each tag is displayed, and the GUI is enabled to receive input instructing the processor 208 to overwrite each original tag 501a, 501b, 501c, 501d, 501e, 501f, 501g and/or 501h individually, as desired.

In another embodiment, the GUI includes an input command object 504 corresponding to an instruction to overwrite the original metadata for all tags 501 with the metadata obtained from the recognition server 101 for all tags 503. When selected, all tags of the received metadata are accepted in one step, e.g., without having to manually accept each tag.

At block 405, the processor 208 receives a signal indicating the user has selected via the GUI one or more original tags 501a, 501b, 501c, 501d, 501e, 501f, 501g, and/or 501h to be modified. For example, if the user selects the input command object 502a that corresponds to the title tag, then the input/output interface 211 transmits to the processor 208 a signal indicating such a selection.

At block 406, the processor 208 overwrites each tag according to the selection(s) at block 405. For example, if the processor 208 receives a signal indicating the user has selected input command object 502a corresponding to the title tag, then the processor 208 overwrites the original title tag metadata 501a, “Unknown”, with the recognition server title tag metadata 503a, “Who's Gonna Stop the Rain”.

In some embodiments, the tags are metadata fields, such as ID3 tags, that allow media item attribute information to be stored within a media item file itself. In this case, at block 406, the processor 208 overwrites the original metadata with the recognition server metadata in the tag which is part of the media item file itself. In other embodiments, the tags are stored in a database (not shown) that is distinct from the media item file, and can be stored within the user device storage device 210 or the recognition server storage device 212. In this case, at block 406, the processor 208 writes the metadata received from the recognition server 101 into the database tag entry that corresponds to the media item. Each tag entry is stored in the database in association with an identifier of the corresponding media item.

FIG. 6 is a sample graphical user interface (GUI) 600 for modifying metadata of a single video media item. With reference to FIGS. 4 and 6, in one embodiment, each tag of the metadata 603a, 603b, 603c, 603d, 603e, 603f and/or 603g (collectively 603) received from the recognition server 101 is displayed beside the corresponding tag of the original metadata 601a, 601b, 601c, 601d, 601e, 601f and/or 601g (collectively 601), e.g., metadata previously stored on the content source 102 or storage device 210 for the media item. Above the tags of the metadata 603 obtained from the recognition server 101 is an input command object 602 of an instruction to overwrite the original metadata tags 601 with the tags of the metadata 603 obtained from the recognition server 101. This enables the user to accept all tags of the metadata 603 obtained from the recognition server 101 in one step, e.g., without having to manually accept each tag 603a,603b, 603c, 603d, 603e, 603f and/or 603g.

### C. Multiple-Media-Item Mode

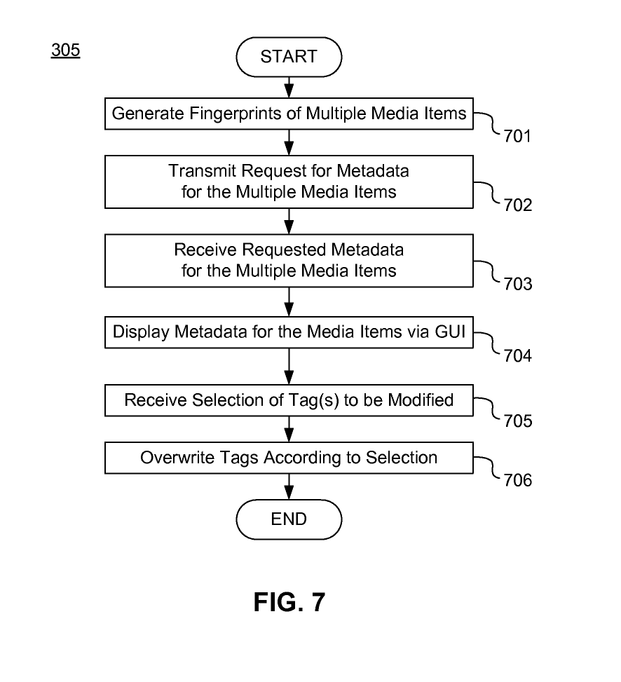

FIG. 7 is a flowchart diagram illustrating an exemplary procedure 305 for modifying metadata of multiple media items.

At block 701, the processor 208 generates fingerprints of the multiple media items that were selected at block 301 (FIG. 3), by performing a recognition procedure, such as audio fingerprinting which is described above, on the media items.

At block 702, the processor 208 transmits to the recognition server 101 over the network 103 a request for metadata of the multiple media items corresponding to the generated fingerprints. The recognition server processor 203 accesses the recognition server database 202 to identify fingerprints stored therein that match the fingerprints received from the user device processor 208. The recognition server processor 203 accesses the recognition server database 202 to obtain metadata stored therein, particularly metadata corresponding to the media items associated with the matched fingerprints.

At block 703, the recognition server processor 203 transmits the recognition server metadata to the user device processor 208 over the network 103.

At block 704, the user device processor 208 forwards the metadata received from the network to the client application 105 to be formatted into a user-viewable format. The client application 105 formats the metadata received from the recognition server 101 into a user-viewable format and displays the metadata received from the recognition server 101 to the user via the GUI on the input/output interface 211.

FIG. 8 is a sample graphical user interface (GUI) 800 for modifying metadata of multiple media items, particularly songs. With reference to FIGS. 7 and 8, in one embodiment, tags of the metadata 803a, 803b and 803c (collectively 803) received from the network for each media item are displayed beside the corresponding tags of the original metadata 801a, 801b, 801c, 801d, 801e and/or 801f (collectively 801), e.g., metadata previously stored on the content source 102 or storage device 210 for the media items. Beside each media item is an input command object 802a, 802b, and/or 802c (collectively 802) corresponding to an instruction to overwrite the original metadata tags 801 with the metadata tags 803 received from the recognition server 101. When selected, each of the original tags 801 is overwritten with the metadata tags 803 received from the recognition server 101 on a media-item-by-media-item basis, as desired.

In another embodiment, the GUI includes an input command object 804 corresponding to an instruction to overwrite the original metadata for all tags 801 with the metadata stored in the recognition server 101 for all tags 803. When selected, all tags of the metadata received from the recognition server 101 are accepted in one step, e.g., without having to manually accept each tag.

In yet another embodiment, the input command objects 805a, 805b and 805c (collectively 805) correspond to instructions to review tag details, and are displayed beside the media items. This enables a user to review tag details, such as the tag details shown in FIG. 5, for each media item individually.

At block 705, the processor 208 receives a signal indicating one or more original tags 801a, 801b, 801c, 801d, 801e and/or 801f have been selected to be modified. For example, if the user selects the display object 802a that corresponds to the tags 801a and 803a, then the input/output interface 211 transmits to the processor 208 a signal indicating such a selection.

At block 706, the processor 208 overwrites each tag according to the selection(s) at block 705. For example, if the processor 208 receives a signal indicating the user has selected input command object 802a corresponding to the tags 801a and 803a, then the processor 208 overwrites the original title tag metadata 801a with the tag metadata 803a received from the recognition server 101.

As described above, in some embodiments, the tags are metadata fields, such as ID3 tags, that allow media item attribute information to be stored within a media item file itself. In this case, at block 706, the processor 208 overwrites the original metadata with the metadata received from the recognition server 101 in the tag which is part of the media item file itself. In other embodiments, the tags are stored in a database (not shown) that is distinct from the media item file, and can be stored within the user device storage device 210 or the recognition server storage device 212. In this case, at block 706, the processor 208 writes the received metadata into the database tag entry that corresponds to the media item. Each tag entry is stored in the database in association with an identifier of the corresponding media item.

### D. Automatic Mode

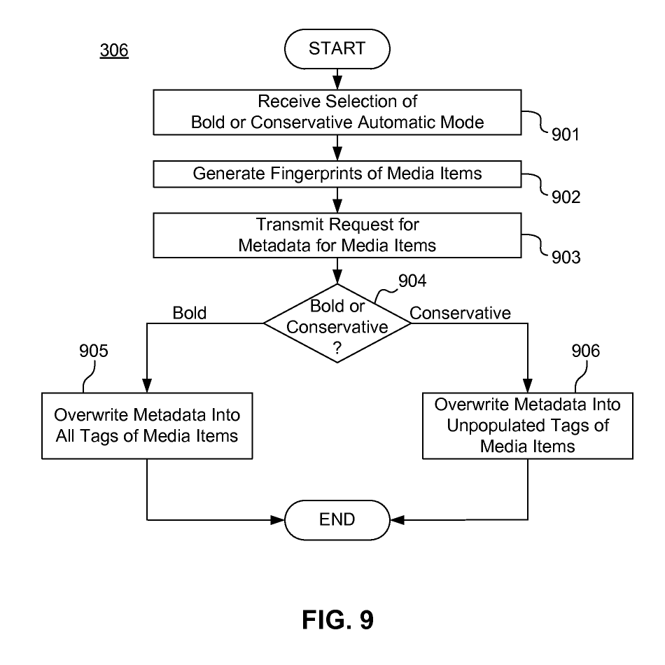

FIG. 9 is a flowchart diagram illustrating an exemplary procedure 306 for automatically modifying metadata of multiple media items.

At block 901, the processor 208 receives a selection of bold automatic mode or a conservative automatic mode. A user selects a bold automatic mode by selecting an input command object corresponding to an instruction to perform bold automatic media item modification. A user selects a conservative automatic mode by selecting an input command object corresponding to an instruction to perform conservative automatic media item modification.

At block 902, the processor 208 generates fingerprints of all the media items that were selected at block 301 (FIG. 3), by performing a recognition procedure, such as audio fingerprinting which is described above, on the media items. In some embodiments, at block 901, the processor 208 generates fingerprints of all the media items stored in the storage device 210 or the content source(s) 102, as the case may be, without requiring user selection of such media items. In this way, the media items are automatically modified while requiring minimal interaction of the user.

At block 903, the processor 208 transmits to the recognition server 101 over the network 103 a request for recognition server metadata of the media items corresponding to the generated fingerprints. The recognition server processor 203 accesses the recognition server database 202 to identify fingerprints stored therein that match the fingerprints received from the user device processor 208. The recognition server processor 203 accesses the recognition server database 202 to obtain metadata corresponding to the media items associated with the matched fingerprints. The recognition server processor 203 transmits the metadata to the user device processor 208 over the network 103.

At block 904, the processor 208 determines whether to implement a bold automatic mode or a conservative automatic mode according to the selection received at block 901.

If the processor 208 determines at block 904 to implement a bold automatic mode then, at block 905, the processor 208 overwrites all tags for the original metadata with the corresponding tags from the metadata received at block 903. This enables the user to modify an entire collection of media item metadata while requiring minimal user interaction.

If the processor 208 determines at block 904 to implement a conservative automatic mode then, at block 906, the processor 208 overwrites empty tags, e.g., tags that are unpopulated with any data, for the original metadata with the corresponding tags from the metadata received at block 903. In this case, the processor 208 does not overwrite populated tags, e.g., tags that are populated with data, for the original metadata. This enables the user to populate any unpopulated tags of original metadata, while preserving any populated tags of original metadata, which the user may have previously edited.

As described above, in some embodiments, the tags are metadata fields, such as ID3 tags, that allow media item attribute information to be stored within a media item file itself. In this case, at block 905 or 906, as the case may be, the processor 208 overwrites the original metadata with the metadata received from the recognition server 101 in the tag which is part of the media item file itself. In other embodiments, the tags are stored in a database (not shown) that is distinct from the media item file, and can be stored within the user device storage device 210 or the recognition server storage device 212. In this case, at block 905 or 906, as the case may be, the processor 208 writes the metadata received from the recognition server 101 into the database tag entry that corresponds to the media item. Each tag entry is stored in the database in association with an identifier of the corresponding media item.

In some embodiments, after the processor 208 has completed automatically modifying media item metadata according the procedure 306, the GUI displays a graphical display object informing the user of the completion of the automatic procedure 306.

### E. Remote Item Modification

### 1. Other User Devices

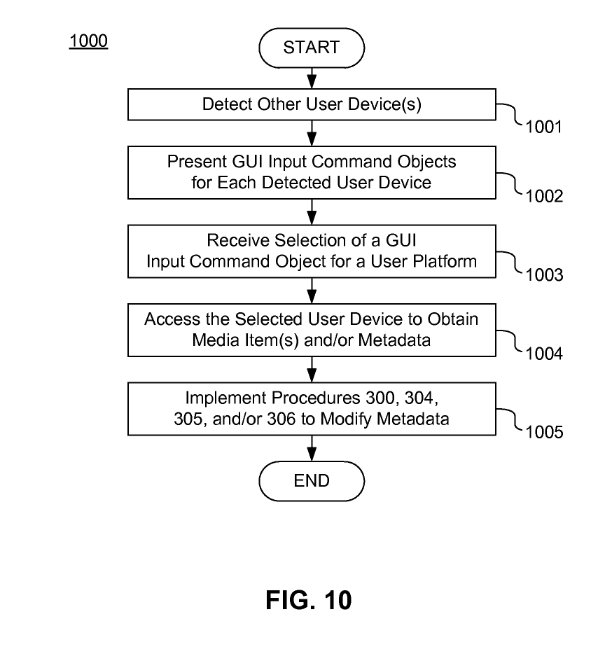

FIG. 10 is a flowchart diagram illustrating an exemplary procedure 1000 for remotely modifying metadata of media items.

At block 1001, the processor 208 detects other user devices 104b, 104c, 104d, 104e, 104f and/or 104g by polling the network 103. In some embodiments, the processor 208 periodically polls the network 103 without requiring user interaction. Alternatively, or in addition, the processor 208 polls the network 103 in response to receiving selection, via the input/output interface 211, of an input command object corresponding to an instruction to poll the network 103.

At block 1002, the GUI displays user-selectable input command objects for each user device 104b, 104c, 104d, 104e, 104f and/or 104g detected at block 1001, correspondingly. The user can instruct the processor 208 to access one of the user devices, for example, user device 104g, detected at block 1001 by selecting, via the input/output interface 211, the input command object corresponding to the user device 104g.

At block 1003, the processor 208 receives a signal indicating that the user has selected one of the input command objects displayed at block 1002. The signal is generated by the input/output interface 211 in response to the user selecting one of the input command objects displayed at block 1002.

At block 1004, the processor 208 remotely accesses the other user device, for example, the user device 104g, that corresponds to the input command object selected at block 1003 to obtain media items and/or metadata stored on the other user device 104g.

At block 1005, the processor 208 implements the procedures 300 and 304-306 discussed above with respect to FIGS. 3-8, for the metadata remotely accessed and/or obtained at block 1004. This enables the user to remotely modify metadata on a remote user device 104, such as a network-attached storage (NAS) 104e, via another user device, such as a personal computer 104b.

### 2. Web Sites

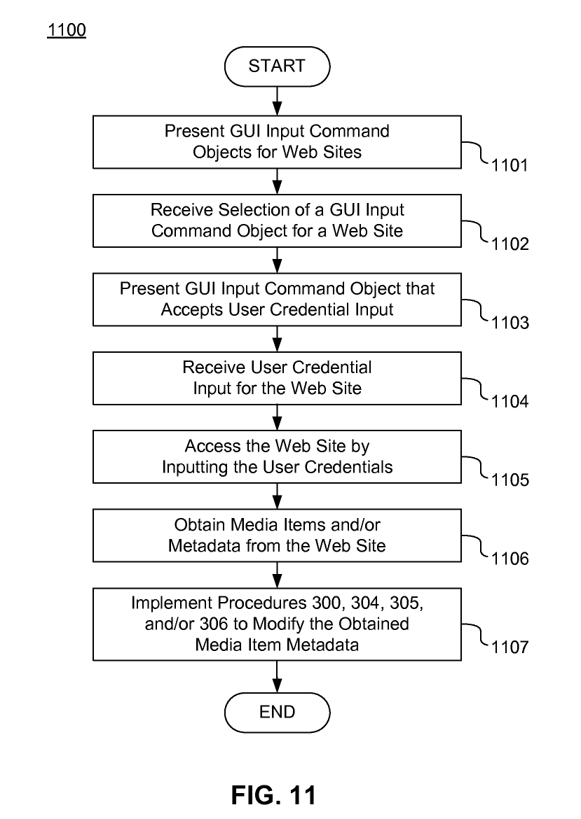

FIG. 11 is a flowchart diagram illustrating an exemplary procedure 1100 for remotely modifying metadata of media items from a Web site, such as a social networking Web site.

At block 1101, the GUI displays user-selectable input command objects for Web sites, correspondingly. The user can instruct the processor 208 to access one of the Web sites by selecting, via the input/output interface 211, the input command object corresponding to the Web site.

At block 1102, the processor 208 receives a signal indicating that the user has selected one of the input command objects displayed at block 1101. The signal is generated by the input/output interface 211 in response to the user selecting one of the input command objects displayed at block 1102.

At block 1103, the GUI displays objects that accept user credential input, if required, for the Web site selected at block 1102. The user inputs the user credential input into the display object.

At block 1104, the processor 208 receives the user credential input of block 1103.

At block 1105 the processor 208 accesses the corresponding Web site by inputting the user credential input of block 1103.

At block 1106, the processor 208 accesses the selected Web site to obtain any media items and/or metadata stored on the Web site in association with the user corresponding to the user credentials.

At block 1107, the processor 208 implements the procedures 300 and 304, 305 and/or 306 discussed above with respect to FIGS. 3-8, for the metadata remotely accessed and/or obtained at block 1105. This enables the user to remotely modify metadata via a user device, such as a personal computer 104b.

### V. Exemplary Computer-Readable Medium Implementation

The example embodiments described above such as, for example, the systems 100 and 200, the procedures 300, 304, 305, 306, 1000, and 1100, the user interfaces 500, 600, and 800, or any part(s) or function(s) thereof, may be implemented by using hardware, software or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary in any of the operations described herein. For example, the client application 105 may automatically modify media content metadata without receiving user input via the user device 104. In other words, the operations may be completely implemented with machine operations. Useful machines for performing the operation of the example embodiments presented herein include general purpose digital computers or similar devices.

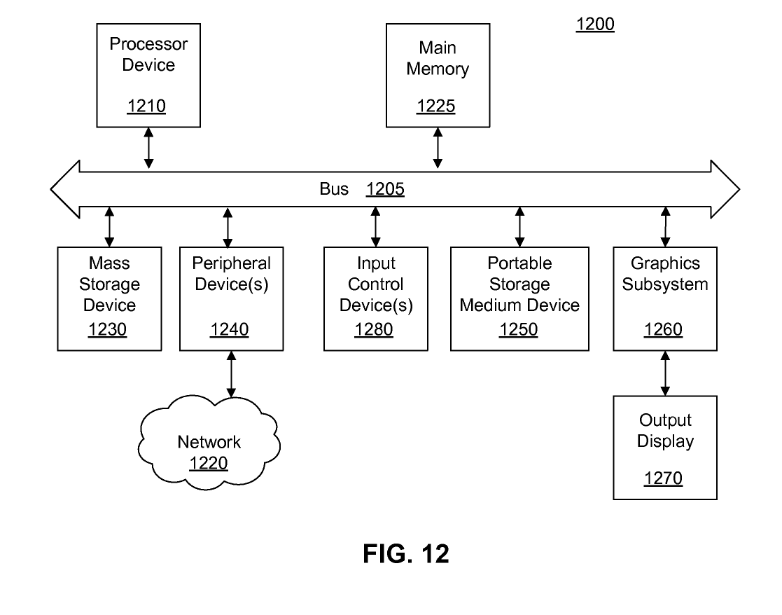

FIG. 12 is a high-level block diagram of a general and/or special purpose computer system 1200, in accordance with some embodiments. The computer system 1200 may be, for example, a user device, a user computer, a client computer and/or a server computer, among other things.

The computer system 1200 preferably includes without limitation a processor device 1210, a main memory 1225, and an interconnect bus 1205. The processor device 1210 may include without limitation a single microprocessor, or may include a plurality of microprocessors for configuring the computer system 1200 as a multi-processor system. The main memory 1225 stores, among other things, instructions and/or data for execution by the processor device 1210. The main memory 1225 may include banks of dynamic random access memory (DRAM), as well as cache memory.

The computer system 1200 may further include a mass storage device 1230, peripheral device(s) 1240, portable storage medium device(s) 1250, input control device(s) 1280, a graphics subsystem 1260, and/or an output display 1270. For explanatory purposes, all components in the computer system 1200 are shown in FIG. 12 as being coupled via the bus 1205. However, the computer system 1200 is not so limited. Devices of the computer system 1200 may be coupled through one or more data transport means. For example, the processor device 1210 and/or the main memory 1225 may be coupled via a local microprocessor bus. The mass storage device 1230, peripheral device(s) 1240, portable storage medium device(s) 1250, and/or graphics subsystem 1260 may be coupled via one or more input/output (I/O) buses. The mass storage device 1230 is preferably a nonvolatile storage device for storing data and/or instructions for use by the processor device 1210. The mass storage device 1230 may be implemented, for example, with a magnetic disk drive or an optical disk drive. In a software embodiment, the mass storage device 1230 is preferably configured for loading contents of the mass storage device 1230 into the main memory 1225.

The portable storage medium device 1250 operates in conjunction with a nonvolatile portable storage medium, such as, for example, a compact disc read only memory (CD-ROM), to input and output data and code to and from the computer system 1200. In some embodiments, the software for storing an internal identifier in metadata may be stored on a portable storage medium, and may be inputted into the computer system 1200 via the portable storage medium device 1250. The peripheral device(s) 1240 may include any type of computer support device, such as, for example, an input/output (I/O) interface configured to add additional functionality to the computer system 1200. For example, the peripheral device(s) 1240 may include a network interface card for interfacing the computer system 1200 with a network 1220.

The input control device(s) 1280 provide a portion of the user interface for a user of the computer system 1200. The input control device(s) 1280 may include a keypad and/or a cursor control device. The keypad may be configured for inputting alphanumeric and/or other key information. The cursor control device may include, for example, a mouse, a trackball, a stylus, and/or cursor direction keys. In order to display textual and graphical information, the computer system 1200 preferably includes the graphics subsystem 1260 and the output display 1270. The output display 1270 may include a cathode ray tube (CRT) display and/or a liquid crystal display (LCD). The graphics subsystem 1260 receives textual and graphical information, and processes the information for output to the output display 1270.

Each component of the computer system 1200 may represent a broad category of a computer component of a general and/or special purpose computer. Components of the computer system 1200 are not limited to the specific implementations provided here.

Portions of the invention may be conveniently implemented by using a conventional general purpose computer, a specialized digital computer and/or a microprocessor programmed according to the teachings of the present disclosure, as will be apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the processes of the invention. The storage medium may include without limitation a floppy disk, a mini disk, an optical disc, a Blu-ray Disc, a DVD, a CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer-readable medium or media, some implementations include software for controlling both the hardware of the general and/or special computer or microprocessor, and for enabling the computer or microprocessor to interact with a human user or other mechanism utilizing the results of the invention. Such software may include without limitation device drivers, operating systems, and user applications. Ultimately, such computer-readable media further includes software for performing aspects of the invention, as described above.

Included in the programming and/or software of the general and/or special purpose computer or microprocessor are software modules for implementing the processes described above.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

1. A method for modifying media content metadata, the method comprising:
receiving, via a graphical user interface, a signal indicating selection of a media item;
receiving, via the graphical user interface, a signal indicating selection of a mode from a group of modes including a single-media-item mode, a multiple-media-item mode, and an automatic mode;
generating, by a processor, a fingerprint of the media item;
transmitting, to a recognition server over a communication network, a request for metadata of the media item, the request including the fingerprint;
receiving, over the communication network, the metadata of the media item; and
storing, in at least one of a digital file of original metadata corresponding to the media item and a database, at least a portion of the metadata received from the recognition server according to the selected mode.

2. The method of claim 1, further comprising:
causing the metadata received from the recognition server and the original metadata to be displayed via the graphical user interface;
receiving a selection of a tag of the original metadata of the media item; and
modifying the tag of the original metadata based on the metadata received from the recognition server.

3. The method of claim 1, further comprising:
receiving, via the graphical user interface, a selection of an automatic mode from a group of automatic modes including a bold automatic mode and a conservative automatic mode;
storing, in at least one of the digital file of the original metadata corresponding to the media item and the database, all tags of the metadata received from the recognition server if the bold automatic mode is selected; and
storing, in at least one of the digital file of the original metadata corresponding to the media item and the database, tags of the metadata received from the recognition server corresponding to unpopulated tags of the original metadata if the conservative automatic mode is selected.

4. The method of claim 1, wherein the receiving a signal indicating selection of the media item further includes:
detecting, over the communication network, a user device;
causing an input command object corresponding to the detected user device to be displayed by the graphical user interface;
receiving, via the graphical user interface, selection of the input command object; and
accessing the detected user device via the communication network to obtain at least one of the media item and the original metadata of the media item.

5. The method of claim 1, further comprising:
causing an input command object corresponding to a Web site to be displayed via the graphical user interface;
receiving, via the graphical user interface, selection of the input command object; and
accessing the Web site via the communication network to obtain at least one of the media item and the original metadata of the media item, wherein the accessing includes inputting user credentials received via the graphical user interface into the Web site.

6. The method of claim 4, wherein the user device includes at least one of a personal computer (PC), a portable computer, a mobile telephone, a television (TV), a digital video recorder (DVR), a set-top-box (STB), a network-attached storage (NAS), and a gaming device.

7. The method of claim 1, wherein the communications network includes at least one of a broadcast network, a wide area network (WAN), the Internet, a DLNA-compliant network, a home network, and an intranet.

8. A system for modifying media content metadata, the system comprising at least one processor configured to:
receive, via a graphical user interface, a signal indicating selection of a media item;
receive, via the graphical user interface, a signal indicating selection of a mode from a group of modes including a single-media-item mode, a multiple-media-item mode, and an automatic mode;
generate a fingerprint of the media item;
transmit, to a recognition server over a communication network, a request for metadata of the media item, the request including the fingerprint;
receive, over the communication network, the metadata of the media item; and
store, in at least one of a digital file of original metadata corresponding to the media item and a database, at least a portion of the metadata received from the recognition server according to the selected mode.

9. The system of claim 8, wherein the processor is further configured to:
cause the metadata received from the recognition server and the original metadata to be displayed via the graphical user interface;
receive a selection of a tag of the original metadata of the media item; and
modify the tag of the original metadata based on the metadata received from the recognition server.

10. The system of claim 8, wherein the processor is further configured to:
receive, via the graphical user interface, a selection of an automatic mode from a group of automatic modes including a bold automatic mode and a conservative automatic mode;
store, in at least one of the digital file of the original metadata corresponding to the media item and the database, all tags of the metadata received from the recognition server if the bold automatic mode is selected; and
store, in at least one of the digital file of the original metadata corresponding to the media item and the database, tags of the metadata received from the recognition server corresponding to unpopulated tags of the original metadata if the conservative automatic mode is selected.

11. The system of claim 8, wherein the processor is further configured to:
detect, over the communication network, a user device;
cause an input command object corresponding to the detected user device to be displayed by the graphical user interface;
receive, via the graphical user interface, selection of the input command object; and
access the detected user device via the communication network to obtain at least one of the media item and the original metadata of the media item.

12. The system of claim 8, wherein the processor is further configured to:
cause an input command object corresponding to a Web site to be displayed via the graphical user interface;
receive, via the graphical user interface, selection of the input command object; and
access the Web site via the communication network to obtain at least one of the media item and the original metadata of the media item, wherein the accessing includes inputting user credentials received via the graphical user interface into the Web site.

13. The system of claim 11, wherein the user device includes at least one of a personal computer (PC), a portable computer, a mobile telephone, a television (TV), a digital video recorder (DVR), a set-top-box (STB), a network-attached storage (NAS), and a gaming device.

14. The system of claim 8, wherein the communications network includes at least one of a broadcast network, a wide area network (WAN), the Internet, a DLNA-compliant network, a home network, and an intranet.

15. A computer-readable medium having stored thereon sequences of instructions, the sequences of instructions including instructions, which, when executed by a processor, cause the processor to perform:
receiving, via a graphical user interface, a signal indicating selection of a media item;
receiving, via the graphical user interface, a signal indicating selection of a mode from a group of modes including a single-media-item mode, a multiple-media-item mode, and an automatic mode;
generating a fingerprint of the media item;
transmitting, to a recognition server over a communication network, a request for metadata of the media item, the request including the fingerprint;
receiving, over the communication network, the metadata of the media item; and
storing, in at least one of a digital file of original metadata corresponding to the media item and a database, at least a portion of the metadata received from the recognition server according to the selected mode.

16. The computer-readable medium according to claim 15, wherein the sequences of instructions further include instructions, which, when executed by the processor, cause the processor to perform:
causing the metadata received from the recognition server and the original metadata to be displayed via the graphical user interface;
receiving a selection of a tag of the original metadata of the media item; and
modifying the tag of the original metadata based on the metadata received from the recognition server.

17. The computer-readable medium according to claim 15, wherein the sequences of instructions further include instructions, which, when executed by the processor, cause the processor to perform:
receiving, via the graphical user interface, a selection of an automatic mode from a group of automatic modes including a bold automatic mode and a conservative automatic mode;
storing, in at least one of the digital file of the original metadata corresponding to the media item and the database, all tags of the metadata received from the recognition server if the bold automatic mode is selected; and
storing, in at least one of the digital file of the original metadata corresponding to the media item and the database, tags of the metadata received from the recognition server corresponding to unpopulated tags of the original metadata if the conservative automatic mode is selected.

18. The computer-readable medium according to claim 15, wherein the sequences of instructions further include instructions, which, when executed by the processor, cause the processor to perform:
detecting, over the communication network, a user device;
causing an input command object corresponding to the detected user device to be displayed by the graphical user interface;
receiving, via the graphical user interface, selection of the input command object; and
accessing the detected user device via the communication network to obtain at least one of the media item and the original metadata of the media item.

19. The computer-readable medium according to claim 15, wherein the sequences of instructions further include instructions, which, when executed by the processor, cause the processor to perform:
causing an input command object corresponding to a Web site to be displayed via the graphical user interface;
receiving, via the graphical user interface, selection of the input command object; and
accessing the Web site via the communication network to obtain at least one of the media item and the original metadata of the media item, wherein the accessing includes inputting user credentials received via the graphical user interface into the Web site.

20. The computer-readable medium according to claim 18, wherein the user device includes at least one of a personal computer (PC), a portable computer, a mobile telephone, a television (TV), a digital video recorder (DVR), a set-top-box (STB), a network-attached storage (NAS), and a gaming device.

21. The computer-readable medium according to claim 15, wherein the communications network includes at least one of a broadcast network, a wide area network (WAN), the Internet, a DLNA-compliant network, a home network, and an intranet.
